(19) United States
(12) Patent Application Publication
(10) Pub. No.: US 2017/0120278 A1
(43) Pub. Date: May 4, 2017

(54) SUBSTRATE PROCESSING APPARATUS

(71) Applicant: SCREEN Holdings Co., Ltd., Kyoto (JP)

(72) Inventor: Koji HASHIMOTO, Kyoto (JP)

(21) Appl. No.: 15/340,442

(22) Filed: Nov. 1, 2016

(30) Foreign Application Priority Data
Nov. 2, 2015 (JP) 2015-215961

(51) Int. Cl. B05B 12/02; B08B 3/02; B08B 3/08; B05B 9/00; B05B 15/02

(52) U.S. Cl. CPC B05B 12/02; B05B 9/00; B05B 15/0258; B08B 3/08; B08B 3/02

(57) ABSTRACT

A substrate processing apparatus includes a chamber that defines an internal space in which a plurality of types of chemicals are supplied to a substrate at different timings, an individual exhaust flow path that removes an atmosphere within the chamber through an exhaust inlet and an exhaust cleaning device that forms a dispersion region where a removal liquid, which removes a chemical contained in an atmosphere, is dispersed in at least one of a position on an upstream side of the exhaust inlet and a position within the individual exhaust flow path by discharging the removal liquid into air.

### BACKGROUND OF THE INVENTION

1. Field of the Invention

The present invention relates to a substrate processing apparatus for processing a substrate. Examples of substrates to be processed include semiconductor wafers, substrates for liquid crystal displays, substrates for plasma displays, substrates for FEDs (field emission displays), substrates for optical disks, substrates for magnetic disks, substrates for magneto-optical disks, substrates for photomasks, ceramic substrates, substrates for solar cells, etc.

2. Description of Related Art

Japanese Patent Application Publication No. 2010-226043 discloses a single substrate processing type substrate processing apparatus that processes substrates one by one. The substrate processing apparatus includes a processing chamber in which a substrate is processed and a collection pipe which exhausts an atmosphere within the processing chamber to the outside of the processing chamber. In the processing chamber, hydrofluoric acid processing which supplies hydrofluoric acid to the substrate, SC1 processing which supplies SC1 to the substrate and replacement processing which replaces pure water on the substrate with IPA (isopropyl alcohol) are performed.

Since in the substrate processing apparatus, hydrofluoric acid, SC1 and IPA are supplied to the substrate within the processing chamber at different timings, an atmosphere containing hydrofluoric acid, an atmosphere containing SC1 and an atmosphere containing IPA are sequentially passed through the collection pipe. When an atmosphere containing a chemical such as hydrogen fluoride (hereinafter referred to as a “chemical atmosphere”) is passed through the collection pipe, the chemical contained in the chemical atmosphere may be adhered to the inner circumferential surface of the collection pipe.

When an atmosphere containing a chemical which is different in type from the chemical adhered to the inner circumferential surface of the collection pipe is passed through the collection pipe, a plurality of types of chemicals are brought into contact with each other within the collection pipe, with the result that particles may be produced. For example, when an acidic chemical is brought into contact with an alkaline chemical, a salt may be produced. When an organic chemical (chemical whose main component is an organic compound) is brought into contact with another type of chemical, a carbide may be produced. When the particles within the collection pipe are passed back into the processing chamber due to a variation in exhaust pressure and adhere to the substrate, the substrate is contaminated.

### SUMMARY OF THE INVENTION

A preferred embodiment of the present invention provides a substrate processing apparatus including a chamber that defines an internal space in which a plurality of types of chemicals are supplied to a substrate at different timings, an individual exhaust flow path that includes an exhaust inlet into which an atmosphere within the chamber flows and that exhausts the atmosphere within the chamber through the exhaust inlet and an exhaust cleaning device that forms a dispersion region, where a removal liquid which removes a chemical contained in an atmosphere is dispersed, in at least one of a position on an upstream side of the exhaust inlet and a position within the individual exhaust flow path by discharging the removal liquid into air.

In this configuration, a plurality of types of chemicals are sequentially supplied to the substrate within the chamber. The chemical atmosphere (the atmosphere containing the chemical) produced within the chamber is exhausted through the exhaust inlet from the chamber to the individual exhaust flow path. The dispersion region where the removal liquid is dispersed is formed in at least one of the position on the upstream side of the exhaust inlet and the position within the individual exhaust flow path. Hence, the chemical atmosphere is brought into contact with the removal liquid either within the chamber or within the individual exhaust flow path.

When the chemical contained in the chemical atmosphere is brought into contact with the removal liquid either within the chamber or within the individual exhaust flow path, the amount of chemical contained in the chemical atmosphere is reduced. Thus, it is possible to reduce the amount of chemical that adheres to the inner surface of the individual exhaust flow path. Hence, even when an atmosphere passes through the individual exhaust flow path and contains a chemical that is different in type from the chemical contained in the chemical atmosphere that has already passed through the individual exhaust flow path, the number of particles produced within the individual exhaust flow path can be reduced. In this way, it is possible to reduce the number of particles which are passed back from the individual exhaust flow path to the chamber, with the result that it is possible to enhance the cleanliness of the substrate.

The chemical may be a liquid (chemical liquid) or a gas (chemical gas). The chemical gas may be the vapor of a chemical or may be a gas containing the mist of a chemical. Specific examples of the chemical include an acidic chemical, an alkaline chemical and an organic chemical (chemical whose main component is an organic compound such as alcohol). When the chemical is soluble in water, the removal liquid is preferably a water-containing liquid whose main component is water such as pure water.

The exhaust cleaning device may include a removal liquid nozzle which discharges the removal liquid. The removal liquid nozzle may discharge the removal liquid upward or downward or may discharge the removal liquid horizontally. When the removal liquid nozzle discharges the removal liquid, a strip-shaped or conical dispersion region is formed.

The removal liquid nozzle may be a shower nozzle which linearly discharges the removal liquid from a plurality of circular discharge ports, maybe a spray nozzle which sprays the removal liquid so as to form the mist of the removal liquid or may be a slit nozzle which discharges the removal liquid from a slit-shaped discharge port so as to form a strip-shaped liquid film.

In the preferred embodiment, at least one of the following features may be added to the substrate processing apparatus.

The exhaust cleaning device forms the dispersion region at the same height as at least a portion of the exhaust inlet.

In this configuration, the dispersion region where the removal liquid is dispersed is formed at the same height as at least a portion of the exhaust inlet. When the exhaust inlet differs in height from the dispersion region, the distance from the exhaust inlet to the dispersion region is increased. This causes an increase in the length of the path through which the chemical atmosphere, in which the chemical component is not removed yet, passes. Hence, the dispersion region is arranged at the same height as at least a portion of the exhaust inlet, and thus it is possible to decrease the region where a plurality of types of chemicals can make contact with each other. In this way, it is possible to reduce the number of particles produced within the individual exhaust flow path.

The exhaust cleaning device may include a removal liquid nozzle which discharges the removal liquid toward the same height (position in the vertical direction) as at least a portion of the exhaust inlet.

The exhaust cleaning device includes a plurality of removal liquid nozzles that respectively form a plurality of the dispersion regions in different positions in an exhaust direction that is a direction in which an atmosphere exhausted from the chamber flows.

In this configuration, since a plurality of dispersion regions are aligned in a direction in which the atmosphere exhausted from the chamber is passed, the chemical atmosphere is sequentially passed through the dispersion regions. In this way, since the number of times and the time the chemical atmosphere is brought into contact with the removal liquid are increased, the amount of chemical contained in the chemical atmosphere can be further reduced. In this way, it is possible to further reduce the number of particles produced within the individual exhaust flow path.

The dispersion regions may be formed in a position on the upstream side of the exhaust inlet and in one or more positions within the individual exhaust flow path or may be formed in a plurality of positions within the individual exhaust flow path.

Each of the removal liquid nozzles includes a plurality of removal liquid discharge ports that discharge the removal liquid and that are aligned in an intersection direction intersecting the exhaust direction, and in two of the removal liquid nozzles adjacent to each other in the exhaust direction, the plurality of the removal liquid discharge ports provided in one of the two removal liquid nozzles are displaced in the intersection direction with respect to the plurality of the removal liquid discharge ports provided in the other removal liquid nozzle.

In this configuration, the removal liquid is discharged from a plurality of removal liquid discharge ports aligned in the intersection direction. Thus, a strip-shaped curtain of the removal liquid is formed, and the removal liquid is dispersed in the strip-shaped dispersion region. Since the plurality of removal liquid discharge ports on the upstream side are displaced in the intersection direction with respect to the plurality of removal liquid discharge ports on the downstream side, even when the chemical atmosphere is passed through without hitting the curtain of the removal liquid on the upstream side, the chemical atmosphere is brought into contact with the curtain of the removal liquid on the downstream side. Hence, it is possible to reliably bring the chemical contained in the chemical atmosphere into contact with the removal liquid, with the result that it is possible to reduce the amount of chemical contained in the chemical atmosphere.

The intersection direction may be a direction perpendicular to the exhaust direction or may be a direction which is inclined with respect to the exhaust direction. In other words, the intersection direction is a direction other than a direction parallel to the exhaust direction.

The exhaust cleaning device further includes a plurality of removal liquid valves that correspond to the removal liquid nozzles, respectively and that individually switch between a supplying state in which the removal liquid is supplied to the removal liquid nozzle and a supply stop state in which the supply of the removal liquid to the removal liquid nozzle is stopped.

In this configuration, the discharge and the discharge stop of the removal liquid are switched by the opening and closing of a plurality of removal liquid valves for each removal liquid nozzle. The number of the removal liquid nozzles that are discharging the removal liquid is equal to the number of the removal liquid valves that are open. The removal liquid dispersed over the dispersion region applies resistance to the atmosphere exhausted from the chamber. Hence, when the removal liquid nozzle discharges the removal liquid, the flow rate (exhaust flow rate) of the atmosphere exhausted from the chamber is changed. For example, the exhaust flow rate when all the removal liquid nozzles discharge the removal liquid is lower than the exhaust flow rate when only portion of the removal liquid nozzles discharges the removal liquid. Hence, the discharges of the removal liquid from the removal liquid nozzles are individually switched, and thus it is possible to adjust the exhaust flow rate.

The removal liquid valve includes a valve body which forms a flow path, a valve member which is arranged within the flow path and an actuator which moves the valve member. The actuator may be a pneumatic actuator or an electric actuator or may be an actuator other than these. The controller of the substrate processing apparatus controls the actuator to open and close the removal liquid valve.

The substrate processing apparatus further includes a substrate holding unit that holds the substrate horizontally within the chamber, a substrate rotating unit that rotates the substrate held by the substrate holding unit, a processing liquid supply unit that supplies a processing liquid to the substrate held by the substrate holding unit and a controller that controls the exhaust cleaning device, the substrate rotating unit and the processing liquid supply unit. The exhaust cleaning device includes a removal liquid valve that switches between a supplying state in which the removal liquid is supplied to the removal liquid nozzle and a supply stop state in which the supply of the removal liquid to the removal liquid nozzle is stopped so as to change the number of the removal liquid nozzles that are discharging the removal liquid.

The controller is programmed and configured to perform a processing liquid supply step of supplying the processing liquid to the substrate within the chamber, a dry step of drying the substrate by removing the processing liquid supplied to the substrate in the processing liquid supply step due to the rotation of the substrate so as to dry the substrate, a first exhaust cleaning step of making one or more but less than all of a first number of the removal liquid nozzles discharge the removal liquid while performing the processing liquid supply step and a second exhaust cleaning step of making a second number of the removal liquid nozzles larger than the first number discharge the removal liquid while performing the dry step.

In this configuration, after the processing liquid supply step in which the processing liquid is supplied to the substrate, the dry step in which the processing liquid supplied to the substrate in the processing liquid supply step is removed from the substrate is performed. The heat of the substrate is taken by the processing liquid when the processing liquid on the substrate is evaporated. Hence, the temperature of the substrate is lowered when the dry step is performed. In addition, when the flow rate of the atmosphere exhausted from the chamber is high, a strong airflow is formed close to the substrate, with the result that the evaporation of the processing liquid is facilitated and that the substrate is cooled by the airflow. When the temperature of the substrate is rapidly lowered, a water mark may be formed by condensation on the substrate.

The removal liquid is discharged during a period in which the processing liquid is supplied to the substrate and during a period in which the substrate is dried. The number (the second number) of removal liquid nozzles which discharge the removal liquid when the dry step is performed is larger than the number (the first number) of removal liquid nozzles which discharge the removal liquid when the processing liquid supply step is performed. As the number of removal liquid nozzles which discharge the removal liquid is increased, the number of dispersion regions is increased, with the result that the resistance applied to the atmosphere exhausted from the chamber is increased. Hence, during the dry step, the intensity of the airflow close to the substrate can be reduced. In this way, it is possible to reduce a decrease in the temperature of the substrate during the dry step.

The controller is a computer which includes a processor and a memory. The controller controls the substrate processing apparatus according to a recipe indicating the processing conditions and the processing procedures of the substrate, and thereby makes the substrate processing apparatus perform the processing liquid supply step, etc. The processing liquid may be a water-containing liquid whose main component is water such as pure water or may be a liquid of an organic solvent having higher volatility than water. An example of the organic solvent described above is isopropyl alcohol. Isopropyl alcohol is an alcohol which has a lower boiling point than water and which has a lower surface tension than water.

The processing liquid supply unit includes an organic chemical liquid nozzle that discharges, as the processing liquid, a liquid of isopropyl alcohol.

In this configuration, the liquid of isopropyl alcohol on the substrate is removed by the rotation of the substrate, and thus the substrate is dried. Since isopropyl alcohol has high volatility, when the substrate is dried, the temperature of the substrate is more likely to be rapidly lowered. Hence, the number of removal liquid nozzles which discharge the removal liquid is increased when the dry step is performed, and thus it is possible to reduce or prevent the rapid lowering of the temperature of the substrate in the dry step. In this way, it is possible to reduce or prevent the occurrence of a water mark.

The chamber includes a bottom portion defining a butt that is disposed in the internal space of the chamber and stores the removal liquid discharged from the exhaust cleaning device.

In this configuration, the removal liquid discharged from the exhaust cleaning device is stored in the butt provided on the bottom portion of the chamber. The chemical contained in the chemical atmosphere floating within the chamber is removed at the bottom portion of the chamber. Hence, the chemical in the chemical atmosphere can be removed before the chemical atmosphere enters the individual exhaust flow path. Furthermore, since the removal liquid discharged for forming the dispersion region is recycled in the butt, it is possible to reduce the amount of removal liquid consumed.

The exhaust cleaning device may include a removal liquid nozzle which discharges the removal liquid toward a position within the chamber. The inner surface of the individual exhaust flow path may include an inclination portion which guides the removal liquid within the individual exhaust flow path into the chamber.

The substrate processing apparatus further includes a cleaning liquid nozzle that cleans an interior of the chamber by discharging cleaning liquid, which is the same type of liquid as the removal liquid discharged by the exhaust cleaning device, within the chamber, and the chamber includes a bottom portion defining a butt that is disposed in the internal space of the chamber and stores the cleaning liquid discharged from the cleaning liquid nozzle.

In this configuration, the cleaning liquid which is the same type of liquid as the removal liquid discharged by the exhaust cleaning device is discharged within the chamber. In this way, the interior of the chamber is cleaned. The cleaning liquid which has cleaned the interior of the chamber is stored in the butt provided on the bottom portion of the chamber. The chemical contained in the chemical atmosphere floating within the chamber is removed at the bottom portion of the chamber. Hence, the chemical in the chemical atmosphere can be removed before the chemical atmosphere enters the individual exhaust flow path. Furthermore, since the cleaning liquid discharged to clean the interior of the chamber is recycled in the butt, it is possible to reduce the amount of removal liquid consumed.

The interior of the chamber, that is, a target to be cleaned with the cleaning liquid may be the inner surface of the chamber or an inner member arranged within the chamber. The inner member may be a cylindrical guard which receives the processing liquid scattered from the substrate to the surrounding thereof, may be a shield plate which has a horizontal posture and which is arranged above the substrate or may be a nozzle arm including the tip end portion to which a processing liquid nozzle that discharges the processing liquid toward the substrate is attached.

The substrate processing apparatus includes a plurality of the chambers, a plurality of the exhaust cleaning devices that correspond to the chambers, respectively, a plurality of the individual exhaust flow paths that are connected to the chambers, respectively and a collection exhaust flow path that is connected to the individual exhaust flow paths.

In this configuration, the chemical atmospheres exhausted from a plurality of chambers to a plurality of individual exhaust flow paths are passed into the collection exhaust flow path. In the chemical atmospheres that passed into the collection exhaust flow path, the amounts of chemicals contained in the chemical atmospheres are reduced in advance by the exhaust cleaning devices. Hence, a plurality of types of chemicals are suppressed or prevented from coming into contact with each other in the collection exhaust flow path. Furthermore, since the individual exhaust flow paths are collected in the collection exhaust flow path, it is not necessary to provide, for each of the individual exhaust flow paths, exhaust facilities, etc., for producing a suction force.

The exhaust outlets of the individual exhaust flow paths may be connected to the collection exhaust flow path in the same position or may be connected to the collection exhaust flow path in different positions in the exhaust direction.

The individual exhaust flow paths include respective exhaust outlets that discharge the atmospheres, exhausted from the chambers, into the collection exhaust flow path, the exhaust outlets are open at an inner surface of the collection exhaust flow path and are spaced in the vertical direction when seen horizontally and a canopy portion that is protruded from an upper edge of the exhaust outlet into the collection exhaust flow path is provided in at least one of the exhaust outlets.

In this configuration, when a droplet of the chemical is produced in the exhaust outlet of the individual exhaust flow path, the droplet is exhausted from the exhaust outlet into the collection exhaust flow path, and is passed downward along the inner surface of the collection exhaust flow path. Since when a plurality of exhaust outlets are seen horizontally, the exhaust outlets are spaced in the vertical direction, the droplet passed downward along the inner surface of the collection exhaust flow path may enter the exhaust outlet on the lower side. However, since the canopy portion which is protruded from the upper edge of the exhaust outlet into the collection exhaust flowpath is provided, it is possible to reduce or prevent the entry of the droplet of the chemical exhausted from the exhaust outlet on the upper side into the exhaust outlet on the lower side.

As long as a plurality of exhaust outlets are aligned in the vertical direction when seen horizontally, the exhaust outlets may be arranged on a vertical plane or may be arranged on a plane inclined with respect to the vertical direction. The canopy portion preferably extends from the upper edge of the exhaust outlet obliquely downwardly. In this case, since the droplet of the chemical is guided along the upper surface of the canopy portion obliquely downwardly, the droplet of the chemical can be fed downward while being moved away from the exhaust outlet on the lower side.

Two of the canopy portions are respectively provided in the exhaust outlets adjacent to each other in the exhaust direction, and when the two canopy portions are seen vertically from above, at least a portion of the canopy portion on a downstream side in the exhaust direction is hidden by the canopy portion on an upstream side in the exhaust direction.

In this configuration, all or a portion of the canopy portion on the downstream side is hidden by the canopy portion on the upstream side. The droplet of the chemical on the canopy portion is dropped downward from the edge of the canopy portion. When the canopy portion on the downstream side is protruded from the canopy portion on the upstream side when seen vertically, the droplet dropped from the canopy portion on the upstream side is adhered to the canopy portion on the downstream side. Thus, different types of chemicals may be brought into contact with each other on the canopy portion on the downstream side. Hence, the canopy portion on the downstream side is hidden by the canopy portion on the upstream side, and thus it is possible to reduce or prevent the contact of the chemicals described above.

The substrate processing apparatus further includes a valve member that is arranged within the individual exhaust flow path and that changes a flow rate of an atmosphere exhausted from the chamber to the individual exhaust flow path by changing a flow passage area of the individual exhaust flow path, and the exhaust cleaning device forms the dispersion region at a position within the individual exhaust flow path by discharging the removal liquid toward the valve member.

In this configuration, a negative pressure (exhaust pressure) which sucks the atmosphere within the chamber into the individual exhaust flow path is adjusted by the valve member of an exhaust damper. The exhaust cleaning device discharges the removal liquid toward the valve member so as to form, within the individual exhaust flow path, the dispersion region where the removal liquid is dispersed. A portion of the removal liquid is held on the surface of the valve member. The chemical atmosphere within the individual exhaust flow path not only makes contact with the removal liquid which is dispersed in the air but also makes contact with the removal liquid held on the surface of the valve member. In this way, it is possible to further reduce the amount of chemical contained in the chemical atmosphere. Furthermore, since the removal liquid is held by the member (valve member) which is normally provided within the individual exhaust flow path, it is possible to reduce an increase in the number of components.

The above and other objects, features, and effects of the present invention will become more apparent from the following detailed description of the preferred embodiments with reference to the attached drawings.

### BRIEF DESCRIPTION OF THE DRAWINGS

FIG. 1 is a horizontal schematic view of the interior of a processing unit included in a substrate processing apparatus according to a preferred embodiment of the present invention.

FIG. 2 is a schematic view for illustrating the exhaust system of the substrate processing apparatus.

FIG. 3 is a schematic view when a plurality of removal liquid nozzles included in an exhaust cleaning device are seen horizontally.

FIG. 4 is a schematic view when the removal liquid nozzles are seen from below.

FIG. 5 is a time chart showing an example where a chemical atmosphere is cleaned with a removal liquid.

FIG. 6 is a schematic view showing removal liquid nozzles according to another preferred embodiment of the present invention.

### DETAILED DESCRIPTION OF THE PREFERRED EMBODIMENT

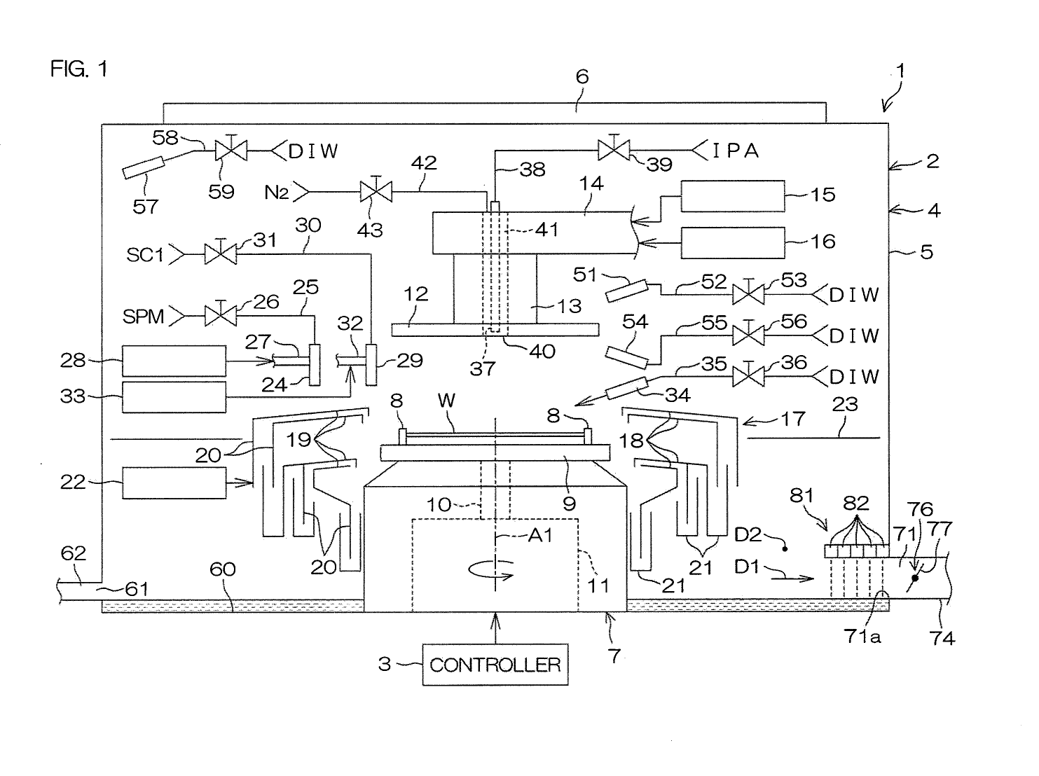

FIG. 1 is a horizontal schematic view of the interior of a processing unit 2 included in a substrate processing apparatus 1 according to a preferred embodiment of the present invention. FIG. 1 shows vertical cross-sections of a chamber 4, a cup 17 and a partition panel 23.

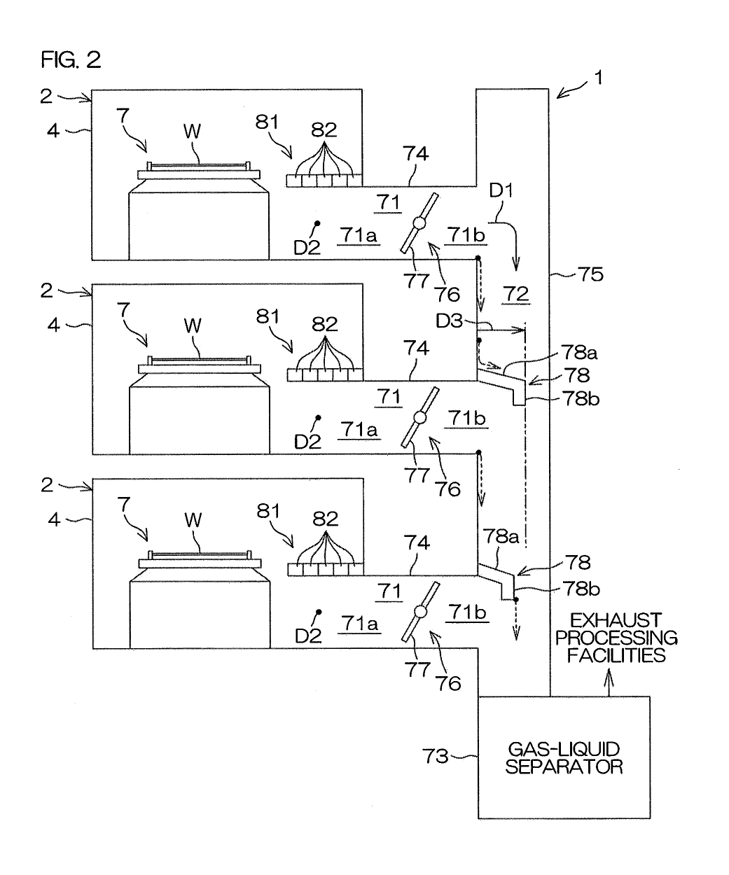

The substrate processing apparatus 1 is a single substrate processing type apparatus in which a disk-shaped substrate W such as a semiconductor wafer is processed one by one. The substrate processing apparatus 1 includes a plurality of processing units 2 that process the substrate W using a processing fluid such as a processing liquid or a processing gas, a transfer robot (not shown) that transfers the substrate W to the plurality of processing units 2, and a controller (control device) 3 that controls the substrate processing apparatus 1. Although not illustrated, the plurality of processing units 2 form four towers disposed at four positions, which are horizontally spaced, respectively. Each tower includes a plurality of processing units 2 (for example, three processing units 2) stacked in the up/down direction (refer to FIG. 2).

The processing unit 2 includes a chamber 4 having an internal space, a spin chuck 7 that rotates the substrate W around a vertical rotation axis A1 passing through the center portion of the substrate W while holding the substrate W horizontally inside the chamber 4, and a plurality of nozzles that discharge processing liquids toward the substrate W. The processing unit 2 further includes a disk-shaped shield plate 12 that is held in a horizontal orientation above the substrate W, a cup 17 that receives a processing liquid having scattered outward from the substrate W, and the partition panel 23 that divides a portion of the internal space of the chamber 4 around the cup 17 into two space aligned in the up/down direction.

The chamber 4 includes a box-shaped partition wall 5 that houses the spin chuck 7, etc., an FFU 6 (fan filter unit) as a blower unit that feeds clean air (air filtered by a filter) inside the partition wall 5 through an upper portion of the partition wall 5. The partition wall 5 includes an upper wall disposed above the substrate W, a bottom wall disposed below the substrate W, and a side wall extending from an outer edge of the bottom wall to an outer edge of the upper wall. The FFU 6 is disposed above the partition wall 5. Although not illustrated, there is a rectifying plate between the FFU 6 and the shield plate 12 which includes a plurality of penetrating holes provided in the entire area of the rectifying plate. When the FFU 6 feeds clean air downward into the chamber 4, a downflow is formed within the chamber 4. The substrate W is processed with such a downflow being formed within the chamber 4.

The spin chuck 7 includes a disk-shaped spin base 9 held in a horizontal orientation, a plurality of chuck pins 8 that holds the substrate W in a horizontal orientation above the spin base 9, and a chuck opening/closing mechanism (not shown) that opens and closes the plurality of chuck pins 8. The spin chuck 7 further includes a spin shaft 10 extending downward from a central portion of the spin base 9, and a spin motor 17 that rotates the spin shaft 10 to rotate the substrate W and the spin base 9 around the rotation axis A1. The spin chuck 7 is not limited to a clamping type chuck in which the plurality of chuck pins 8 are brought into contact with the circumferential end surface of the substrate W, and may be a vacuum type chuck in which the rear surface (lower surface) of the substrate W, which is a non-device forming surface, is suctioned onto an upper surface of the spin base 9 to hold the substrate W horizontally.

The shield plate 12 has a disk-shaped configuration having an outer diameter larger than a diameter of the substrate W. The shield plate 12 is supported in a horizontal orientation by a support shaft 13 extending in the up/down direction. The support shaft 13 is supported by a support arm extending horizontally at a position higher than the shield plate 12. The shield plate 12 is disposed under the support shaft 13. The centerline of the shield plate 12 is disposed on the rotation axis A1. The lower surface of the shield plate 12 is parallel to the upper surface of the substrate W and faces the upper surface of the substrate W.

The shield plate 12 is coupled to a shield plate rotating unit 15 which rotates the shield plate 12 around the vertical rotation axis A1 with respect to a support arm 14 and a shield plate raising and lowering unit 16 which vertically raises and lowers the support arm 14 together with the shield plate 12 and a support shaft 13. The shield plate raising and lowering unit 16 vertically raises and lowers the shield plate 12 between a processing position and a retracted position (a position shown in FIG. 1). The retracted position is an upper position in which the lower surface of the shield plate 12 is separated upward from the upper surface of the substrate W such that the nozzle can enter between the substrate W and the shield plate 12. The processing position is a lower position in which the lower surface of the shield plate 12 is close to the upper surface of the substrate W such that the nozzle is prevented from entering between the substrate W and the shield plate 12.

The cup 17 surrounds the spin chuck 7. The cup 17 includes a plurality of guards 18 which receive the processing liquid scattered outward from the substrate W and a plurality of trays 21 which receive the processing liquid guided downward by the guards 18. The guards 18 are concentrically arranged so as to surround the spin chuck 7. The guard 18 includes a cylindrical inclination portion 19 which extends obliquely upwardly toward the vertical rotation axis A1 and a cylindrical guide portion 20 which extends downward from the lower end portion (outer end portion) of the inclination portion 19. The upper end of the inclination portion 19 corresponding to the upper end of the guard 18 has an inside diameter greater than the outside diameters of the substrate W and the shield plate 12. A plurality of inclination portions 19 overlap each other in the up/down direction. The trays 21 correspond to the guards 18, respectively. The tray 21 forms an annular groove located under the lower end of the guide portion 20.

The guards 18 are connected to a guard raising and lowering unit 22 which individually raises and lowers the guards 18. The guard raising and lowering unit 22 vertically raises and lowers the guard 18 between a processing position and a retracted position. The processing position is an upper position in which the upper end of the guard 18 is located higher than the substrate W. The retracted position is a lower position in which the upper end of the guard 18 is located lower than the substrate W. FIG. 1 shows a state that two guards 18 on the outside are arranged in the processing position and the remaining two guards 18 are arranged in the retracted position. When the processing liquid is supplied to the rotating substrate W, the guard raising and lowering unit 22 locates at least one of the guards 18 in the processing position, and makes the inner circumferential surface of the guard 18 oppose the circumferential end surface of the substrate W horizontally.

The partition panel 23 is located between the guard 18 of the cup 17 and the side wall of the chamber 4. The partition panel 23 is supported by a plurality of support columns (not shown) which extend upward from the bottom wall of the chamber 4. FIG. 1 shows an example where the upper surface of the partition panel 23 is horizontal. The upper surface of the partition panel 23 may be inclined so as to extend obliquely downwardly toward the vertical rotation axis A1. One partition panel 23 may be provided or a plurality of partition panels 23 which are located at the same height may be provided. The outer edge of the partition panel 23 is separated horizontally from the inner surface of the chamber 4, and the inner edge of the partition panel 23 is separated horizontally from the outer circumferential surface of the guard 18. The partition panel 23 is located higher than a spin motor 11.

A plurality of nozzles include a plurality of chemical liquid nozzles which discharge a chemical liquid toward the upper surface of the substrate W and a rinse liquid nozzle 34 which discharges a rinse liquid toward the upper surface of the substrate W. The chemical liquid nozzles include an acidic chemical liquid nozzle 24 which discharges an acidic chemical liquid toward the upper surface of the substrate W, an alkaline chemical liquid nozzle 29 which discharges an alkaline chemical liquid toward the upper surface of the substrate W and an organic chemical liquid nozzle 37 which discharges an organic chemical liquid toward the upper surface of the substrate W. The acidic chemical liquid, the alkaline chemical liquid and the organic chemical liquid are soluble in water.

The acidic chemical liquid nozzle 24 is connected to an acidic chemical liquid pipe 25 which guides the acidic chemical liquid to the acidic chemical liquid nozzle 24. An acidic chemical liquid valve 26 which switches the supply and the supply stop of the acidic chemical liquid to the acidic chemical liquid nozzle 24 is interposed in the acidic chemical liquid pipe 25. When the acidic chemical liquid valve 26 is opened, the acidic chemical liquid is continuously discharged downward from the acidic chemical liquid nozzle 24. The acidic chemical liquid is, for example, an SPM (a mixed liquid of sulfuric acid and hydrogen peroxide solution). As long as the liquid is an acidic chemical liquid, the acidic chemical liquid may be a liquid other than the SPM. For example, the acidic chemical liquid may be hydrofluoric acid, phosphoric acid, etc.

The acidic chemical liquid nozzle 24 is a scan nozzle which is movable within the chamber 4. The acidic chemical liquid nozzle 24 is attached to the tip end portion of a nozzle arm 27 which horizontally extends above the partition panel 23. The acidic chemical liquid nozzle 24 is connected to a nozzle movement unit 28 which moves the nozzle arm 27 so as to move the acidic chemical liquid nozzle 24 in at least one of the vertical direction and the horizontal direction. The nozzle movement unit 28 is a turning mechanism which turns the acidic chemical liquid nozzle 24 about a turning axis extending vertically around the cup 17. The first nozzle movement unit 28 moves the acidic chemical liquid nozzle 24 between a processing position in which the liquid discharged from the acidic chemical liquid nozzle 24 lands on the upper surface of the substrate W and a retracted position in which the acidic chemical liquid nozzle 24 is located around the spin chuck 7 in a plan view.

The alkaline chemical liquid nozzle 29 is connected to an alkaline chemical liquid pipe 30 which guides the alkaline chemical liquid supplied to the alkaline chemical liquid nozzle 29. An alkaline chemical liquid valve 31 which switches the supply and the supply stop of the alkaline chemical liquid to the alkaline chemical liquid nozzle 29 is interposed in the alkaline chemical liquid pipe 30. When the alkaline chemical liquid valve 31 is opened, the alkaline chemical liquid is continuously discharged downward from the alkaline chemical liquid nozzle 29. The alkaline chemical liquid is, for example, an SC-1 (a mixed liquid of ammonia water, hydrogen peroxide solution and water). As long as the liquid is an alkaline chemical liquid, the alkaline chemical liquid may be a liquid other than the SC-1.

The alkaline chemical liquid nozzle 29 is a scan nozzle. The alkaline chemical liquid nozzle 29 is attached to the tip end portion of a nozzle arm 32 which horizontally extends above the partition panel 23. The alkaline chemical liquid nozzle 29 is connected to a nozzle movement unit 33 which moves the nozzle arm 32 so as to move the alkaline chemical liquid nozzle 29 in at least one of the vertical direction and the horizontal direction. The nozzle movement unit 33 is a turning mechanism which turns the alkaline chemical liquid nozzle 29 about a turning axis extending vertically around the cup 17. The second nozzle movement unit 33 moves the alkaline chemical liquid nozzle 29 between a processing position and a retracted position.

The rinse liquid nozzle 34 is a fixed nozzle which is fixed in a predetermined position within the chamber 4. The rinse liquid nozzle 34 may be a scan nozzle. The rinse liquid nozzle 34 is connected to a rinse liquid pipe 35 which guides the rinse liquid supplied to the rinse liquid nozzle 34. A rinse liquid valve 36 which switches the supply and the supply stop of the rinse liquid to the rinse liquid nozzle 34 is interposed in the rinse liquid pipe 35. When the rinse liquid valve 36 is opened, the rinse liquid is discharged downward from the rinse liquid nozzle 34 toward the center portion of the upper surface of the substrate W. The rinse liquid is, for example, pure water (deionized water). The rinse liquid may be any one of carbonated water, electrolytic ion water, hydrogen water, ozone water, and a diluted concentration (for example, about 10 to 100 ppm) of hydrochloric acid water.

The organic chemical liquid nozzle 37 extends along the vertical rotation axis A1 in the up/down direction. The organic chemical liquid nozzle 37 is arranged above the spin chuck 7. The organic chemical liquid nozzle 37 is raised and lowered together with the shield plate 12, the support shaft 13 and the support arm 14. The organic chemical liquid nozzle 37 cannot be rotated with respect to the support arm 14. The organic chemical liquid nozzle 37 is inserted into the support shaft 13. The organic chemical liquid nozzle 37 is surrounded by a tubular flow path 41 which is provided within the support shaft 13. The tubular flow path 41 is connected to a center discharge port 40 which is provided in the center portion of the lower surface of the shield plate 12. The lower end of the organic chemical liquid nozzle 37 is arranged above the center discharge port 40.

The organic chemical liquid nozzle 37 is connected to an organic chemical liquid pipe 38 which guides the organic chemical liquid supplied to the organic chemical liquid nozzle 37. An organic chemical liquid valve 39 which switches the supply and the supply stop of the organic chemical liquid to the organic chemical liquid nozzle 37 is interposed in the organic chemical liquid pipe 38. When the organic chemical liquid valve 39 is opened, the organic chemical liquid is continuously discharged downward from the organic chemical liquid nozzle 37, and is supplied to the upper surface of the substrate W via the center discharge port 40 of the shield plate 12. The organic chemical liquid is, for example, IPA. The organic chemical liquid may be an alcohol other than IPA or may be an organic solvent other than alcohol. For example, the organic chemical liquid may be HFE (hydrofluoroether).

The center discharge port 40 of the shield plate 12 is connected to a gas pipe 42 which guides an inert gas to be supplied to the center discharge port 40. A gas valve 43 which switches the supply and the supply stop of the inert gas to the center discharge port 40 is interposed in the gas pipe 42. When the gas valve 43 is opened, the inert gas is supplied via the tubular flow path 41 to the center discharge port 40, and is continuously discharged downward from the center discharge port 40. When the center discharge port 40 discharges the inert gas in a state where the lower surface of the shield plate 12 is close to the upper surface of the substrate W, a space between the substrate W and the shield plate 12 is filled with the inert gas. The inert gas is, for example, nitrogen gas. The inert gas may be an inert gas such as argon gas other than nitrogen gas.

Processing on the substrate W to be performed in the processing unit 2 will then be described.

The controller 3 includes a memory which stores information such as a program and a processor which controls the substrate processing apparatus 1 according to the information stored in the memory. A recipe that indicates processing procedures and processing steps for the substrate W is stored in the memory. The controller 3 is programed so as to control the substrate processing apparatus 1 based on the recipe to make the processing units 2 perform the steps which will be described below and to make the processing units 2 process the substrate W.

Specifically, in a state where the shield plate 12, the guards 18 and the chemical liquid nozzles are located in the respective retracted positions, the controller 3 makes a transfer robot (not shown) transport the substrate W into the chamber 4 (transport-instep). The controller 3 makes the chuck pins 8 grasp the substrate W after the transfer robot places the substrate Won the spin chuck 7. Thereafter, the controller 3 makes the spin motor 11 start the rotation of the substrate W. In this way, the substrate W is rotated at a liquid processing rotation speed (for example, 10 to 1000 rpm).

After the substrate W is placed on the spin chuck 7, the controller 3 moves the acidic chemical liquid nozzle 24 from the retracted position to the processing position, and opens the acidic chemical liquid valve 26. In this way, the SPM which is an example of the acidic chemical liquid is discharged from the acidic chemical liquid nozzle 24 toward the upper surface of the substrate W being rotated. At this time, the controller 3 may move the acidic chemical liquid nozzle 24 so as to move the landing position where the SPM lands on the substrate W. The SPM is supplied to the entire region of the upper surface of the substrate W. In this way, the upper surface of the substrate W is processed (SPM supply step). The SPM scattered around the substrate W is received by the inner circumferential surface of the guard 18 located in the processing position.

The controller 3 closes the acidic chemical liquid valve 26, moves the acidic chemical liquid nozzle 24 from the processing position to the retracted position, then causes the rinse liquid nozzle 34 to discharge the pure water which is an example of the rinse liquid toward the rotating substrate W by opening the rinse liquid valve 36. The pure water discharged from the rinse liquid nozzle 34 lands on the center portion of the upper surface of the substrate W, and is thereafter passed outward along the upper surface of the substrate W. In this way, the pure water is supplied to the entire region of the upper surface of the substrate W so as to clean away the SPM adhered to the substrate W (rinse liquid supply step). The pure water scattered around the substrate W is received by the inner circumferential surface of the guard 18 located in the processing position.

The controller 3 closes the rinse liquid valve 36 to make the rinse liquid nozzle 34 stop the discharge of the pure water, then moves the alkaline chemical liquid nozzle 29 from the retracted position to the processing position and opens the alkaline chemical liquid valve 31. In this way, the SC-1 which is an example of the alkaline chemical liquid is discharged from the alkaline chemical liquid nozzle 29 toward the upper surface of the substrate W being rotated. At this time, the controller 3 may move the alkaline chemical liquid nozzle 29 so as to move the position where the SC-1 lands on the substrate W. The SC-1 is supplied to the entire region of the upper surface of the substrate W. In this way, the upper surface of the substrate W is processed with the SC-1 (SC-1 supply step). The SC-1 scattered around the substrate W is received by the inner circumferential surface of the guard 18 located in the processing position.

The controller 3 closes the alkaline chemical liquid valve 31, moves the alkaline chemical liquid nozzle 29 from the processing position to the retracted position, then causes the rinse liquid nozzle 34 to discharge the pure water which is an example of the rinse liquid toward the rotating substrate W by opening the rinse liquid valve 36. The pure water discharged from the rinse liquid nozzle 34 lands on the center portion of the upper surface of the substrate W, and is thereafter passed outward along the upper surface of the substrate W. In this way, the pure water is supplied to the entire region of the upper surface of the substrate W so as to clean away the SC-1 adhered to the substrate W (rinse liquid supply step). The pure water scattered around the substrate W is received by the inner circumferential surface of the guard 18 located in the processing position.

The controller 3 closes the rinse liquid valve 36, makes the rinse liquid nozzle 34 stop the discharge of the pure water, then lowers the shield plate 12 from the retracted position to the processing position and opens the organic chemical liquid valve 39. In this way, the IPA which is an example of the organic chemical liquid is discharged from the center discharge port 40 of the shield plate 12 toward the center portion of the upper surface of the substrate W being rotated. At this time, the controller 3 may open the gas valve 43 and cause the center discharge port 40 of the shield plate 12 to discharge nitrogen gas. The IPA is supplied to the entire region of the upper surface of the substrate W. In this way, the pure water on the substrate W is replaced with the IPA, and a liquid film of the IPA which covers the entire region of the upper surface of the substrate W is formed (IPA supply step). The IPA scattered around the substrate W is received by the inner circumferential surface of the guard 18 located in the processing position.

The controller 3 closes the organic chemical liquid valve 39 so as to stop the discharge of the IPA through the shield plate 12, and then makes the spin motor 11 accelerate the substrate W in the rotation direction in a state where the shield plate 12 is located in the processing position and where the center discharge port 40 of the shield plate 12 discharges the nitrogen gas downward. In this way, the substrate W is rotated at a dry speed (for example, a few thousand rpm) higher than the liquid processing speed. The IPA on the substrate W is exhausted around the substrate W by the high-speed rotation of the substrate W. The IPA scattered outward from the substrate W is received by the inner circumferential surface of the guard 18 located in the processing position. In this way, the liquid is removed from the substrate W, and thus the substrate W is dried (dry step).

The controller 3 rotates the substrate W at a high speed for a predetermined period of time, and then makes the spin motor 11 stop the rotation of the substrate W. Thereafter, the controller 3 makes the chuck pins 8 release the grasp of the substrate W. Furthermore, the controller 3 closes the gas valve 43 so as to stop the discharge of the nitrogen gas through the shield plate 12. Furthermore, the controller 3 raises the shield plate 12 from the processing position to the retracted position, and lowers the guards 18 from the processing position to the retracted position. Thereafter, the controller 3 makes the transfer robot (not shown) transport the substrate W out from the chamber 4 (transport-out step). The controller 3 repeats a series of steps from the transport-in step to the transport-out step so as to make the substrate processing apparatus 1 process a plurality of substrates W.

Cleaning of the interior of the chamber 4 will then be described.

The processing unit 2 includes a plurality of cleaning liquid nozzles which discharge a cleaning liquid within the chamber 4 so as to clean the interior of the chamber 4. The cleaning liquid nozzles include an upper cleaning liquid nozzle 51 which discharges the cleaning liquid toward the upper surface of the shield plate 12, a lower cleaning liquid nozzle 54 which discharges the cleaning liquid toward the lower surface of the shield plate 12 and an inner surface cleaning liquid nozzle 57 which discharges the cleaning liquid toward the inner surface of the chamber 4. The lower cleaning liquid nozzle 54 and the inner surface cleaning liquid nozzle 57 are fixed to the chamber 4. The upper cleaning liquid nozzle 51 may be fixed to the chamber 4 or may be fixed to the support shaft 13 supporting the shield plate 12. The cleaning liquid nozzles are located higher than the partition panel 23.

The upper cleaning liquid nozzle 51 is connected to an upper cleaning liquid pipe 52 in which an upper cleaning liquid valve 53 is interposed. Likewise, the lower cleaning liquid nozzle 54 is connected to a lower cleaning liquid pipe 55 in which a lower cleaning liquid valve 56 is interposed, and the inner surface cleaning liquid nozzle 57 is connected to an inner surface cleaning liquid pipe 58 in which an inner surface cleaning liquid valve 59 is interposed. These cleaning liquid valves are opened and closed by the controller 3. The cleaning liquid is, for example, pure water. As long as the cleaning liquid is a water-containing liquid whose main component is water, the cleaning liquid may be a liquid other than pure water. For example, the cleaning liquid may be a rinse liquid other than pure water.

When the substrate W is not present in the chamber 4, the controller 3 makes the upper cleaning liquid nozzle 51, etc., clean the interior of the chamber 4. The controller 3 may perform the chamber cleaning processing each time the processing of one or a plurality of substrates W is completed or may perform the chamber cleaning processing when the maintenance of the substrate processing apparatus 1 is performed.

When the shield plate 12 is cleaned, the controller 3 makes the upper cleaning liquid nozzle 51 and the lower cleaning liquid nozzle 54 discharge the cleaning liquid while rotating the shield plate 12. The cleaning liquid discharged from the upper cleaning liquid nozzle 51 lands on the upper surface of the shield plate 12, and is thereafter passed outward along the upper surface of the shield plate 12. Likewise, the cleaning liquid discharged from the lower cleaning liquid nozzle 54 lands on the lower surface of the shield plate 12, and is thereafter passed outward along the lower surface of the shield plate 12. In this way, the splashes, etc., of the processing liquid adhered to the shield plate 12 when the substrate W is processed are cleaned away by the cleaning liquid, and the upper surface and the lower surface of the shield plate 12 are cleaned by the cleaning liquid.

When the inner surface of the chamber 4 is cleaned, the controller 3 makes the inner surface cleaning liquid nozzle discharge the cleaning liquid. The cleaning liquid discharged from the inner surface cleaning liquid nozzle 57 lands on the inner surface of the chamber 4, and is thereafter passed downward along the inner surface of the chamber 4. In this way, the splashes, etc., of the processing liquid adhered to the chamber 4 when the substrate W is processed are cleaned away by the cleaning liquid, and the inner surface of the chamber 4 is cleaned by the cleaning liquid.

When the shield plate 12 is cleaned, the controller 3 controls the rotation speed of the shield plate 12 such that a portion of the cleaning liquid scattered outward from the shield plate 12 is supplied to the inner surface of the chamber 4. Furthermore, the controller 3 raises and lowers the shield plate 12 in a state where at least one of the upper cleaning liquid nozzle 51 and the lower cleaning liquid nozzle 54 discharges the cleaning liquid toward the shield plate 12 being rotated. The position in which the cleaning liquid scattered outward from the shield plate 12 hits the inner surface of the chamber 4 is moved vertically by the raising and lowering of the shield plate 12. In this way, the cleaning liquid directly hits the wide range of the inner surface of the chamber 4, with the result that the inner surface of the chamber 4 is effectively cleaned.

The bottom surface of the chamber 4 forms a butt 60 that stores the liquid within the chamber 4. The butt 60 has a shallow box-shaped configuration that opens upward. The partition panel 23 and the cup 17 are arranged above the butt 60. The cleaning liquid nozzles individually discharge the cleaning liquid above the partition panel 23. The cleaning liquid is passed through a gap between the outer edge of the partition panel 23 and the chamber 4 and a gap between the inner edge of the partition panel 23 and the cup 17, and is moved downward of the partition panel 23. The cleaning liquid moved downward of the partition panel 23 is stored in the butt 60.

A drain port 61 through which the liquid within the butt 60 is exhausted is arranged in a position separated upward from the bottom surface of the butt 60. Likewise, the exhaust inlet 71a of an individual exhaust flow path 71 which will be described below is arranged in a position separated upward from the bottom surface of the butt 60. When the liquid surface within the butt 60 reaches the drain port 61, a portion of the liquid is exhausted through the drain port 61 to a drain flow path 62. Hence, a certain amount of cleaning liquid is constantly held within the butt 60. When a chemical atmosphere produced within the chamber 4 is brought into contact with the cleaning liquid (pure water) within the butt 60, a chemical contained in the chemical atmosphere is dissolved into the cleaning liquid and is removed from the chemical atmosphere.

The flow of the exhaust will then be described.

A description will be given below with reference to FIGS. 1 and 2. FIG. 2 is a schematic view for illustrating the exhaust system of the substrate processing apparatus 1.

The chamber 4 is connected to an exhaust processing facility, which is provided in a factory where the substrate processing apparatus 1 is installed, via the individual exhaust flow path 71, a collection exhaust flow path 72 and a gas-liquid separator 73 in this order. The individual exhaust flow path 71 is defined by an individual exhaust duct 74, and the collection exhaust flow path 72 is defined by a collection exhaust duct 75. The suction force of the exhaust processing facilities is transmitted via the individual exhaust flow path 71, etc., to each chamber 4. The atmosphere exhausted from the chamber 4 is guided by the individual exhaust flow path 71 and the collection exhaust flow path 72 in an exhaust direction D1. The atmosphere within the collection exhaust flow path 72 is passed into the exhaust processing facility after a liquid component is removed by the gas-liquid separator 73.

Three individual exhaust flowpaths 71 respectively connected to three processing units 2 in the same tower are connected to the same collection exhaust flow path 72. The collection exhaust flowpath 72 extends in the up/down direction Each of the three chambers 4 in the same tower is located on the side of the collection exhaust flow path 72. The three individual exhaust flow paths 71 extend horizontally from the three chambers 4 to the collection exhaust flow path 72. The three individual exhaust flow paths 71 are connected to the collection exhaust flow path 72 at three different positions in the up/down direction. Hence, the distance from the exhaust processing facility to the chamber 4 differs among the three chambers 4. The suction force transmitted from the exhaust processing facility to the chamber 4 differs among the three chambers 4 due to variations in pressure loss.

Variations in the suction force transmitted to the chambers 4 are reduced by three exhaust dampers 76 which are respectively arranged in the three individual exhaust flowpaths 71. The exhaust damper 76 includes a valve member 77 located within the individual exhaust flow path 71. The exhaust damper 76 maybe a manual damper in which the valve member 77 is moved manually or may be an auto-damper which includes an actuator that moves the valve member 77. FIG. 2 shows an example where the valve member 77 has a disk-shaped configuration. When the valve member 77 shown in FIG. 2 is rotated about a rotation axis extending along its diameter, the area of the individual exhaust flow path 71 is increased or decreased, and the flow rate (exhaust flow rate) of the atmosphere discharged from the chamber 4 to the individual exhaust flow path 71 is changed. Hence, it is possible to reduce the variations in the suction force (exhaust pressure) by adjusting the opening degrees of the three exhaust dampers 76.

The individual exhaust flow path 71 includes the exhaust inlet 71a through which the atmosphere within the chamber 4 is passed thereinto. The exhaust inlet 71a corresponds to the upstream end of the individual exhaust flow path 71. FIG. 2 shows an example where the inner surface of the chamber 4 defines the exhaust inlet 71a. The exhaust inlet 71a may be defined by a member other than the chamber 4. For example, when the upstream end of the individual exhaust duct 74 is protruded from the inner surface of the chamber 4 into the chamber 4, the upstream end of the individual exhaust duct 74 may define the exhaust inlet 71a.

The individual exhaust flow path 71 includes an exhaust outlet 71b through which the atmosphere passed into the exhaust inlet 71a is exhausted to the collection exhaust flow path 72. The exhaust outlet 71b corresponds to the downstream end of the individual exhaust flow path 71. When a plurality of exhaust outlets 71b are seen horizontally, the exhaust outlets 71b are spaced in the vertical direction. FIG. 2 shows an example where the three exhaust outlets 71b are on the same vertical plane. When a droplet is produced in the exhaust outlet 71b, the droplet is exhausted from the exhaust outlet 71b into the collection exhaust flow path 72, and is passed downward along the inner surface of the collection exhaust flow path 72. Since when a plurality of exhaust outlets 71b are seen horizontally, the exhaust outlets 71b are spaced in the vertical direction, the droplet passed downward along the inner surface of the collection exhaust flow path 72 may enter the exhaust outlet 71b on the lower side.

A canopy portion 78 which prevents the droplet from being passed into the exhaust outlet 71b extends from the upper edge of the exhaust outlet 71b into the collection exhaust flow path 72. Two canopy portions 78 are respectively connected to the two exhaust outlets 71b on the lower side. The canopy portion 78 includes an upper surface 78a which extends obliquely downwardly from the exhaust outlet 71b toward the downstream side of the collection exhaust flow path 72 and a tip end surface 78b which extends vertically downwardly from the tip end (lower end) of the upper surface 78a. The amount of protrusion of the two canopy portions 78, that is, a distance D3 from the exhaust outlet 71b to the tip end of the canopy portion 78 in the horizontal direction is reduced as the collection exhaust flow path 72 extends to the downstream side thereof. When the two canopy portions 78 are seen vertically from above, the canopy portion 78 on the lower side is hidden by the canopy portion 78 on the upper side.

The droplet (see a black spot in FIG. 2) exhausted downstream from the uppermost exhaust outlet 71b is passed downward from the lower edge of the exhaust outlet 71b along the inner surface of the collection exhaust flow path 72, and reaches the canopy portion 78 on the upper side. The droplet is guided by the upper surface 78a of the canopy portion 78 on the upper side obliquely downwardly. Likewise, the droplet exhausted downstream from the middle exhaust outlet 71b reaches the canopy portion 78 on the lower side, and is thereafter guided by the upper surface 78a of the canopy portion 78 on the lower side obliquely downwardly. Hence, it is possible to reduce or prevent the entry of the droplet of the chemical exhausted from a certain exhaust outlet 71b into another exhaust outlet 71b.

The droplet guided by the upper surface 78a of the canopy portion 78 is dropped downward from the tip end surface 78b of the canopy portion 78 and enters the gas-liquid separator 73. When the canopy portion 78 on the lower side is protruded from the canopy portion 78 on the upper side when seen vertically, the droplet dropped from the canopy portion 78 on the upper side is adhered to the canopy portion 78 on the lower side. Since in each chamber 4, the processing is independently performed, different types of chemicals may be brought into contact with each other on the canopy portion 78 on the lower side. Hence, the canopy portion 78 on the lower side is hidden by the canopy portion 78 on the upper side, and thus it is possible to reduce or prevent the contact of the chemicals described above.

The cleaning of the exhaust will then be described.

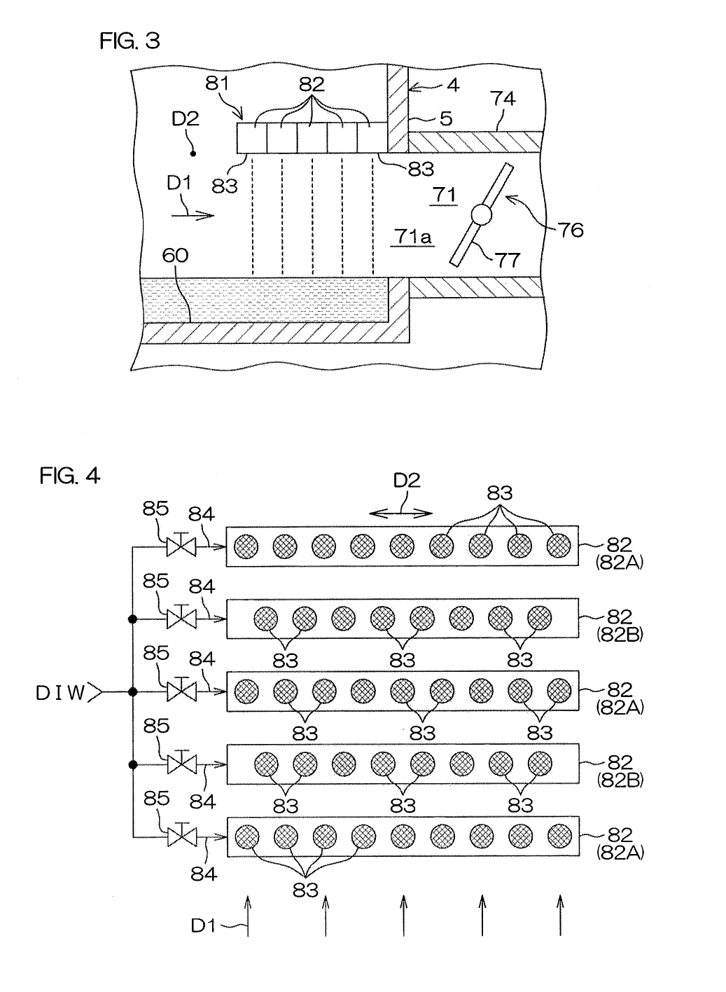

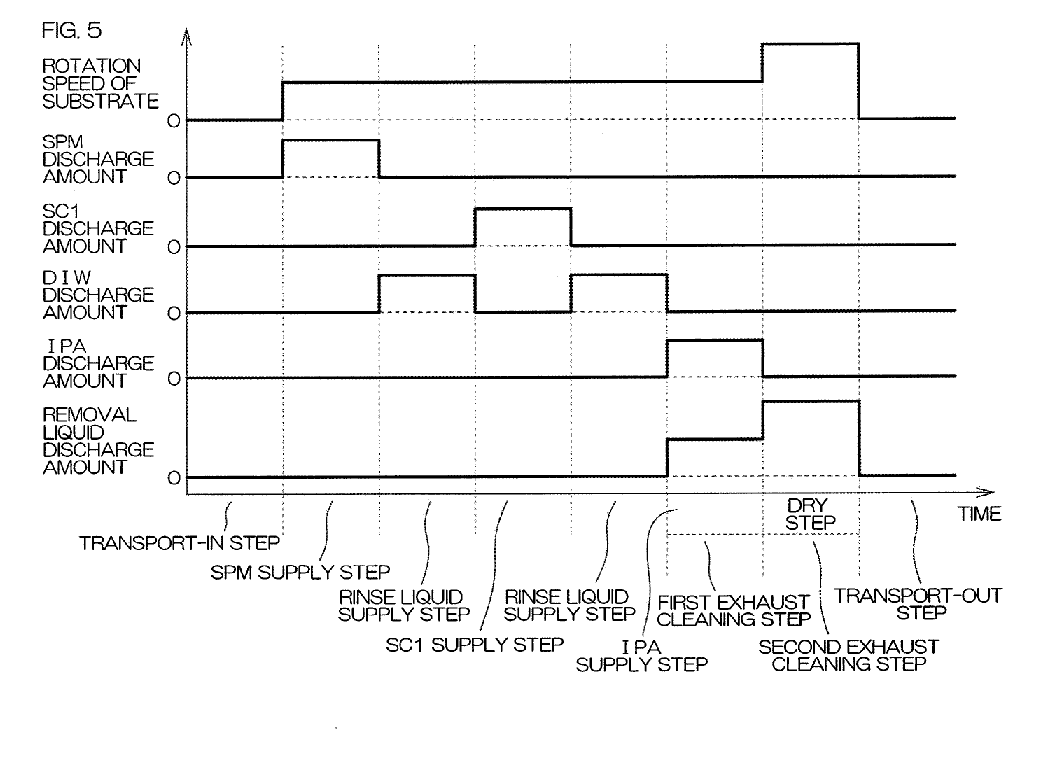

A description will be given below with reference to FIGS. 3 to 5. FIG. 3 is a schematic view when a plurality of removal liquid nozzles 82 included in an exhaust cleaning device 81 are seen horizontally. FIG. 4 is a schematic view when the removal liquid nozzles 82 are seen from below. FIG. 5 is a time chart showing an example where the chemical atmosphere is cleaned by a removal liquid. In FIG. 4, cross-hatched regions represent removal liquid discharge ports 83.

When the chemical liquid reaches the substrate W, the mist and droplets of the chemical liquid are produced. Even when the chemical liquid is scattered from the substrate W or the scattered chemical liquid collides with the guard 18, the mist and droplets of the chemical liquid are produced. Hence, a chemical atmosphere (atmosphere containing the chemical liquid) is produced within the chamber 4. Furthermore, since a plurality of types of chemical liquids are sequentially supplied to the substrate W within the chamber 4, a plurality of types of chemical atmospheres are sequentially produced within the chamber 4.

The substrate processing apparatus 1 includes a plurality of exhaust cleaning devices 81 (scrubbers 81) which remove the chemical liquid contained in the chemical atmosphere. The exhaust cleaning devices 81 correspond to a plurality of chambers 4, respectively. The exhaust cleaning device 81 includes a plurality of removal liquid nozzles 82 which discharge the removal liquid. The removal liquid nozzles 82 are arranged within the chamber 4. The removal liquid nozzles 82 are arranged upstream of the exhaust inlet 71a of the individual, exhaust flow path 71. The removal liquid nozzles 82 are aligned in the exhaust direction D1. The removal liquid nozzles 82 are arranged lower than the substrate W. The removal liquid nozzles 82 are located below the partition panel 23.

FIG. 4 is a diagram when the removal liquid nozzles 82 are seen from below. The removal liquid nozzle 82 is a shower nozzle which forms a plurality of linear liquid flows. The removal liquid nozzle 82 is formed in the shape of a rod which extends in a horizontal intersection direction D2 perpendicular to the exhaust direction Dl. The removal liquid nozzle 82 includes a plurality of removal liquid discharge ports 83 which are spaced regularly in the horizontal intersection direction D2 perpendicular to the exhaust direction D1. Each of the removal liquid discharge ports 83 discharges, for example, the removal liquid vertically in a downward direction. The removal liquid nozzles 82 are parallel to each other and are aligned in the exhaust direction D1.

The removal liquid nozzles 82 include three first removal liquid nozzles 82A and two second removal liquid nozzles 82B which are arranged between the three first removal liquid nozzles 82A. A plurality of removal liquid discharge ports 83 in the second removal liquid nozzles 82B are displaced in the intersection direction D2 with respect to a plurality of removal liquid discharge ports 83 in the first removal liquid nozzle 82A. At least a portion of the removal liquid discharge ports 83 in the second removal liquid nozzle 82B is located between the removal liquid discharge ports 83 in the first removal liquid nozzle 82A in the intersection direction D2. The removal liquid discharge ports 83 in the first removal liquid nozzle 82A and the removal liquid discharge ports 83 in the second removal liquid nozzle 82B are arranged in a staggered configuration.

The removal liquid nozzle 82 is connected to a removal liquid pipe 84 in which a removal liquid valve 85 is interposed. The removal liquid valve 85 and the removal liquid pipe 84 are provided in each of the removal liquid nozzles 82. When the controller 3 opens the removal liquid valve 85, the removal liquid is discharged from the removal liquid nozzle 82 corresponding to this removal liquid valve 85. When the controller 3 increases or decreases the opening of the removal liquid valve 85, the flow rate of removal liquid discharged from the removal liquid nozzle 82 corresponding to this removal liquid valve 85 is changed. The discharges of the removal liquid from the removal liquid nozzles 82 are individually switched. Each of the removal liquid pipes 84 is connected to the same removal liquid supply source. The removal liquid is, for example, pure water. As long as the removal liquid is a water-containing liquid whose main component is water, the removal liquid maybe a liquid other than pure water. For example, the removal liquid may be a rinse liquid other than pure water. The temperature of the removal liquid may be less than room temperature (20 to 30° C.) or may be equal to or more than room temperature.

When one removal liquid nozzle 82 discharges the removal liquid from the removal liquid discharge ports 83, a strip-shaped shower of the removal liquid is formed, and a strip-shaped dispersion region where the removal liquid is dispersed is formed in front of the exhaust inlet 71a. When the removal liquid nozzles 82 discharge the removal liquid, a plurality of dispersion regions stacked in layers in the exhaust direction D1 are formed in front of the exhaust inlet 71a. The exhaust inlet 71a is substantially blocked by a strip-shaped curtain of the removal liquid. Hence, the chemical atmosphere exhausted from the chamber 4 to the individual exhaust flow path 71 is brought into contact with the removal liquid in front of the exhaust inlet 71a. A chemical contained in the chemical atmosphere is dissolved into the removal liquid (pure water) and is removed from the chemical atmosphere.

When the substrate W is processed, the controller 3 opens at least one removal liquid valve 85 so as to discharge the removal liquid to one or more removal liquid nozzles 82. FIG. 5 is a time chart showing an example where the chemical atmosphere is cleaned with the removal liquid. In this example, when the IPA is supplied to the substrate W (when the IPA is discharged from the organic chemical liquid nozzle 37), the controller 3 makes only three (the first number) first removal liquid nozzles 82A discharge the removal liquid. Then, when the IPA is removed from the substrate W so that the substrate W is dried, the controller 3 makes five (the second number) removal liquid nozzles 82 discharge the cleaning liquid.

IPA has an extremely high affinity for water. Hence, as in the example shown in FIG. 5, the chemical atmosphere containing the IPA is brought into contact with the removal liquid (pure water), and thus it is possible to effectively remove the IPA contained in the chemical atmosphere. Furthermore, when the substrate W is dried, since the IPA exhausted from the substrate W vigorously collides with the guard 18, the amount of mist of the IPA produced is increased, with the result that the concentration of the IPA in the chemical atmosphere is increased. Hence, the number of removal liquid nozzles 82 which discharge the removal liquid when the substrate W is dried is increased, and thus it is possible to reduce or prevent an increase in the amount of IPA contained in the chemical atmosphere after the cleaning.

As described above, in the present preferred embodiment, a plurality of types of chemicals (the acidic chemical liquid, the alkaline chemical liquid and the organic chemical liquid) are sequentially supplied to the substrate W within the chamber 4. The chemical atmosphere (atmosphere containing the chemical) produced within the chamber 4 is exhausted through the exhaust inlet 71a from the chamber 4 to the individual exhaust flow path 71. The dispersion region where the removal liquid is dispersed is formed in at least one of a position which is upstream of the exhaust inlet 71a and a position which is within the individual exhaust flow path 71. Hence, the chemical atmosphere is brought into contact with the removal liquid either within the chamber 4 or within the individual exhaust flow path 71.

When the chemical atmosphere is brought into contact with the removal liquid either within the chamber 4 or within the individual exhaust flow path 71, the amount of chemical contained in the chemical atmosphere is reduced. Thus, it is possible to reduce the amount of chemical that adheres to the inner surface of the individual exhaust flow path 71. Hence, even when an atmosphere passes through the individual exhaust flow path 71 and contains a chemical that is different in type from the chemical contained in the chemical atmosphere that has already passed through the individual exhaust flow path 71, the number of particles produced within the individual exhaust flow path 71 can be reduced. In this way, it is possible to reduce the number of particles which are passed back from the individual exhaust flow path 71 to the chamber 4, with the result that it is possible to enhance the cleanliness of the substrate W.

In the present preferred embodiment, the dispersion region where the removal liquid is dispersed is formed at the same height as at least a portion of the exhaust inlet 71a. When the heights of the exhaust inlet 71a and the dispersion region are different from each other, the distance from the exhaust inlet 71a to the dispersion region is increased. This causes an increase in the length of the path through which the chemical atmosphere, in which the chemical component is not removed yet, passes. Hence, the dispersion region is arranged at the same height as at least a portion of the exhaust inlet 71a, and thus it is possible to reduce the region where a plurality of types of chemicals can be brought into contact with each other. In this way, it is possible to reduce the number of particles produced within the individual exhaust flow path 71.

Since in the present preferred embodiment, a plurality of dispersion regions are aligned in a direction in which the atmosphere exhausted from the chamber 4 is passed, the chemical atmosphere is sequentially passed through the dispersion regions. In this way, since the number of times and the time the chemical atmosphere is brought into contact with the removal liquid are increased, the amount of chemical contained in the chemical atmosphere can be further reduced. In this way, it is possible to further reduce the number of particles produced within the individual exhaust flow path 71.

In the present preferred embodiment, the removal liquid is discharged from a plurality of removal liquid discharge ports 83 aligned in the intersection direction D2. In this way, the strip-shaped curtain of the removal liquid is formed, and the removal liquid is dispersed over the strip-shaped dispersion region. Since a plurality of removal liquid discharge ports 83 on the upstream side are displaced with respect to a plurality of removal liquid discharge ports 83 on the downstream side in the intersection direction D2, even when the chemical atmosphere is passed without hitting the curtain of the removal liquid on the upstream side, the chemical atmosphere is brought into contact with the curtain of the removal liquid on the downstream side. Hence, it is possible to reliably bring the chemical contained in the chemical atmosphere into contact with the removal liquid, with the result that it is possible to reduce the amount of chemical contained in the chemical atmosphere.

In the present preferred embodiment, the discharge and the discharge stop of the removal liquid are switched by the opening and closing of a plurality of removal liquid valves 85 for each removal liquid nozzle 82. The controller 3 changes the opening degree of the removal liquid valve 85, and thus the flow rate of the removal liquid discharged from the removal liquid nozzle 82 is adjusted. The number of the removal liquid nozzles 82 that are discharging the removal liquid is equal to the number of the removal liquid valves 85 that are open. The removal liquid dispersed over the dispersion region applies resistance to the atmosphere exhausted from the chamber 4. Hence, when the removal liquid nozzle 82 discharges the removal liquid or the flow rate of the removal liquid discharged from the removal liquid nozzle 82 is changed, the flow rate (exhaust flow rate) of the atmosphere exhausted from the chamber 4 is changed. For example, the exhaust flow rate when all the removal liquid nozzles 82 discharge the removal liquid is lower than the exhaust flow rate when only portion of the removal liquid nozzles 82 discharges the removal liquid. Hence, the discharges of the removal liquid from the removal liquid nozzles 82 are individually switched, and thus it is possible to adjust the exhaust flow rate.

In the present preferred embodiment, after the IPA supply step in which the IPA is supplied to the substrate W, the dry step in which the IPA supplied to the substrate W in the IPA supply step is removed from the substrate W is performed. The heat of the substrate W is taken by the IPA when the IPA on the substrate W is evaporated. Hence, the temperature of the substrate W is lowered when the dry step is performed. When the flow rate of the atmosphere exhausted from the chamber 4 is high, a strong airflow is formed close to the substrate W, with the result that the evaporation of the IPA is facilitated and that the substrate W is cooled by the airflow. When the temperature of the substrate W is rapidly lowered, a water mark may be formed by condensation on the substrate W.

The removal liquid is discharged during a period in which the IPA is supplied to the substrate W and during a period in which the substrate W is dried. The number (the second number) of removal liquid nozzles 82 which discharge the removal liquid when the dry step is performed is larger than the number (the first number) of removal liquid nozzles 82 which discharge the removal liquid when the IPA supply step is performed. As the number of removal liquid nozzles 82 which discharge the removal liquid is increased, the number of dispersion regions is increased, with the result that the resistance applied to the atmosphere exhausted from the chamber 4 is increased. Hence, during the dry step, the intensity of the airflow close to the substrate W can be reduced. In this way, it is possible to reduce a decrease in the temperature of the substrate W during the dry step.

In the present preferred embodiment, the removal liquid discharged from the exhaust cleaning device 81 is stored in the butt 60 provided on the bottom portion of the chamber 4. The chemical contained in the chemical atmosphere floating within the chamber 4 is removed at the bottom portion of the chamber 4. Hence, the chemical in the chemical atmosphere can be removed before the chemical atmosphere enters the individual exhaust flow path 71. Furthermore, since the removal liquid discharged for forming the dispersion region is recycled in the butt 60, it is possible to reduce the amount of removal liquid consumed.

In the present preferred embodiment, the cleaning liquid which is the same type of liquid as the removal liquid discharged by the exhaust cleaning device 81 is discharged within the chamber 4. In this way, the interior of the chamber 4 is cleaned. The cleaning liquid which has cleaned the interior of the chamber 4 is stored in the butt 60 provided on the bottom portion of the chamber 4. The chemical contained in the chemical atmosphere floating within the chamber 4 is removed at the bottom portion of the chamber 4. Hence, the chemical in the chemical atmosphere can be removed before the chemical atmosphere enters the individual exhaust flow path 71. Furthermore, since the removal liquid discharged to clean the interior of the chamber 4 is recycled in the butt 60, it is possible to reduce the amount of removal liquid consumed.

In the present preferred embodiment, the chemical atmospheres exhausted from a plurality of chambers 4 to a plurality of individual exhaust flow paths 71 are passed into the collection exhaust flow path 72. In the chemical atmospheres that passed into the collection exhaust flow path 72, the amounts of chemicals contained are reduced in advance by the exhaust cleaning devices 81. Hence, a plurality of types of chemicals are suppressed or prevented from coming into contact with each other in the collection exhaust flow path 72. Furthermore, since the individual exhaust flow paths 71 are collected in the collection exhaust flow path 72, it is not necessary to provide, for each of the individual exhaust flow paths 71, exhaust facilities, etc., for producing a suction force.

In the present preferred embodiment, when a droplet of the chemical is produced in the exhaust outlet 71b of the individual exhaust flow path 71, the droplet is exhausted from the exhaust outlet 71b into the collection exhaust flow path 72, and is passed downward along the inner surface of the collection exhaust flow path 72. Since when a plurality of exhaust outlets 71b are seen horizontally, the exhaust outlets 71b are spaced in the vertical direction, the droplet passed downward along the inner surface of the collection exhaust flow path 72 may enter the exhaust outlet 71b on the lower side. However, since the canopy portion 78 which is protruded from the upper edge of the exhaust outlet 71b into the collection exhaust flow path 72 is provided, it is possible to reduce or prevent the entry of the droplet of the chemical exhausted from the exhaust outlet 71b on the upper side into the exhaust outlet 71b on the lower side.

In the present preferred embodiment, all or part of the canopy portion 78 on the downstream side is hidden by the canopy portion 78 on the upstream side. The droplet of the chemical on the canopy portion 78 is dropped downward from the edge of the canopy portion 78. When the canopy portion 78 on the downstream side is protruded from the canopy portion 78 on the upstream side when seen vertically, the droplet dropped from the canopy portion 78 on the upstream side is adhered to the canopy portion 78 on the downstream side. Thus, different types of chemicals may be brought into contact with each other on the canopy portion 78 on the downstream side. Hence, the canopy portion 78 on the downstream side is hidden by the canopy portion 78 on the upstream side, and thus it is possible to reduce or prevent the contact of the chemicals described above.

### Other Preferred Embodiments

The present invention is not limited to the contents of the above preferred embodiments, and can be variously modified.

For example, although in the preferred embodiment discussed above, the case where the SPM is supplied to the substrate W and thereafter the SPM on the substrate W is cleaned away by the pure water is described, a hydrogen peroxide solution may be supplied before the supply of the pure water.

Although in the preferred embodiment discussed above, the case where the shield plate 12 is provided is described, the shield plate 12 may be omitted.

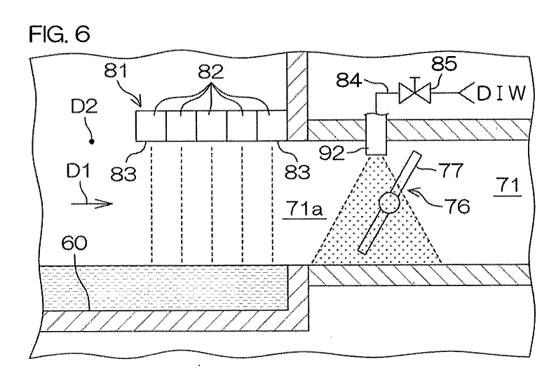

As shown in FIG. 6, the exhaust cleaning device 81 may include a flow path interior removal liquid nozzle 92 which discharges the removal liquid within the individual exhaust flow path 71 instead of, or in addition to the chamber interior removal liquid nozzle 82 which discharges the removal liquid within the chamber 4.

FIG. 6 shows an example where the removal liquid nozzle 92 is a spray nozzle which produces the mist of the removal liquid. The removal liquid nozzle 92 is connected to the removal liquid pipe 84 in which the removal liquid valve 85 is interposed. When the removal liquid nozzle 92 discharges the removal liquid, the mist of the removal liquid is spread in the shape of a cone, and a cone-shaped dispersion region is formed within the individual exhaust flow path 71. The removal liquid nozzle 92 discharges, for example, the removal liquid downward toward the valve member 77 of the exhaust damper 76 arranged within the individual exhaust flow path 71. The removal liquid nozzle 92 may discharge the removal liquid toward a position on the upstream side or on the downstream side of the valve member 77 within the individual exhaust flow path 71.

In this configuration, the flow path interior removal liquid nozzle 92 discharges the removal liquid toward the valve member 77 so as to form, within the individual exhaust flow path 71, the dispersion region where the removal liquid is dispersed. A portion of the removal liquid is held on the surface of the valve member 77. The chemical atmosphere within the individual exhaust flow path 71 not only makes contact with the removal liquid which is dispersed in the air but also makes contact with the removal liquid held on the surface of the valve member 77. In this way, it is possible to further reduce the amount of chemical contained in the chemical atmosphere. Furthermore, since the removal liquid is held by the member (valve member 77) which is normally provided within the individual exhaust flow path 71, it is possible to reduce an increase in the number of components.

Although in the preferred embodiment discussed above, the case where the removal liquid is discharged during the period (the IPA supply step) in which the IPA is supplied to the substrate W and the during the period (the dry step) in which the substrate W is dried is described, the removal liquid may be discharged during a period other than those periods. For example, in addition to, or instead of the IPA supply step and the dry step, during a period (chemical supply step) in which at least one of the SPM and the SC-1 is supplied to the substrate W, the removal liquid may be discharged. During all the periods in which the substrate W is within the chamber 4, the removal liquid may be discharged, or regardless of whether the substrate W is within the chamber 4, the removal liquid may be discharged.

Although in the preferred embodiment discussed above, the case where the number (the second number) of removal liquid nozzles 82 which discharge the removal liquid when the substrate W is dried is larger than the number (the first number) of removal liquid nozzles 82 which discharge the removal liquid when the IPA is supplied to the substrate W is described, the first number may be larger than the second number or may be equal to the second number. Alternatively, in a step other than the IPA supply step and the dry step, the number of removal liquid nozzles 82 which discharge the removal liquid may be adjusted.

The removal liquid nozzle 82 may discharge the removal liquid not only in the downward direction but also in the upward direction or may discharge the removal liquid in the horizontal direction.

Although in the preferred embodiment discussed above, the case where the dispersion region where the removal liquid is dispersed is formed in the position on the upstream side of the exhaust inlet 71a or in the position within the individual exhaust flow path 71 is described, the dispersion region may be formed in the position on the downstream side of the exhaust dampers 76. For example, the dispersion region corresponding to the processing unit 2 on the uppermost side shown in FIG. 2 may be formed in a range from the exhaust damper 76 corresponding to the processing unit 2 to the canopy portion 78 on the upper side corresponding to the processing unit 2. In this case, the dispersion region does not need to be located at the same height as at least a portion of the exhaust inlet 71a. For example, the entire dispersion region may be formed in a position higher or lower than the exhaust inlet 71a.

Although in the preferred embodiment discussed above, the case where a plurality of removal liquid discharge ports 83 on the upstream side are displaced with respect to a plurality of removal liquid discharge ports 83 on the downstream side in the intersection direction D2 is described, the removal liquid discharge ports 83 on the upstream side do not need to be displaced with respect to the removal liquid discharge ports 83 in the intersection direction D2.

Although in the preferred embodiment discussed above, the case where a plurality of removal liquid valves 85 which respectively correspond to a plurality of removal liquid nozzles 82 are provided is described, one removal liquid valve 85 may switch the discharge and the discharge stop and the flow rate of the removal liquid from all the removal liquid nozzles 82.

Although in the preferred embodiment discussed above, the case where when the two canopy portions 78 are seen vertically from above, the canopy portion 78 on the downstream side is hidden by the canopy portion 78 on the upstream side is described, the canopy portion 78 on the downstream side may be protruded from the canopy portion 78 on the upstream side. All or part of the canopy portion 78 may be omitted.

Two or more of any of the arrangements described above may be combined. Two or more of any of the steps described above may be combined.

The present application corresponds to Japanese Patent Application No. 2015-215961 filed on Nov. 2, 2015 in the Japan Patent Office, and the entire disclosure of this application is incorporated herein by reference.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A substrate processing apparatus comprising:
a chamber that defines an internal space in which a plurality of types of chemicals are supplied to a substrate at different timings;
an individual exhaust flow path that includes an exhaust inlet into which an atmosphere within the chamber flows and that exhausts the atmosphere within the chamber through the exhaust inlet; and
an exhaust cleaning device that forms a dispersion region, where a removal liquid which removes a chemical contained in an atmosphere is dispersed, in at least one of a position on an upstream side of the exhaust inlet and a position within the individual exhaust flow path by discharging the removal liquid into air.

2. The substrate processing apparatus according to claim 1,
wherein the exhaust cleaning device forms the dispersion region at the same height as at least a portion of the exhaust inlet.

3. The substrate processing apparatus according to claim 1,
wherein the exhaust cleaning device includes a plurality of removal liquid nozzles that respectively form a plurality of the dispersion regions in different positions in an exhaust direction that is a direction in which an atmosphere exhausted from the chamber flows.

4. The substrate processing apparatus according to claim 3,
wherein each of the removal liquid nozzles includes a plurality of removal liquid discharge ports that discharge the removal liquid and that are aligned in an intersection direction intersecting the exhaust direction, and
in two of the removal liquid nozzles adjacent to each other in the exhaust direction, the plurality of removal liquid discharge ports provided in one of the two removal liquid nozzles are displaced in the intersection direction with respect to the plurality of removal liquid discharge ports provided in the other removal liquid nozzle.

5. The substrate processing apparatus according to claim 3,
wherein the exhaust cleaning device further includes a plurality of removal liquid valves that correspond to the removal liquid nozzles, respectively and that individually switch between a supplying state in which the removal liquid is supplied to the removal liquid nozzle and a supply stop state in which the supply of the removal liquid to the removal liquid nozzle is stopped.

6. The substrate processing apparatus according to claim 3, further comprising:
a substrate holding unit that holds the substrate horizontally within the chamber;
a substrate rotating unit that rotates the substrate held by the substrate holding unit;
a processing liquid supply unit that supplies a processing liquid to the substrate held by the substrate holding unit; and
a controller that controls the exhaust cleaning device, the substrate rotating unit and the processing liquid supply unit,
wherein the exhaust cleaning device includes a removal liquid valve that switches between a supplying state in which the removal liquid is supplied to the removal liquid nozzle and a supply stop state in which the supply of the removal liquid to the removal liquid nozzle is stopped so as to change a number of the removal liquid nozzles that are discharging the removal liquid, and
the controller is programmed and configured to perform:
a processing liquid supply step of supplying the processing liquid to the substrate within the chamber;
a dry step of drying the substrate by removing the processing liquid supplied to the substrate in the processing liquid supply step due to the rotation of the substrate;
a first exhaust cleaning step of making one or more but less than all of a first number of the removal liquid nozzles discharge the removal liquid while performing the processing liquid supply step; and
a second exhaust cleaning step of making a second number of the removal liquid nozzles larger than the first number discharge the removal liquid while performing the dry step.

7. The substrate processing apparatus according to claim 6,
wherein the processing liquid supply unit includes an organic chemical liquid nozzle that discharges, as the processing liquid, a liquid of isopropyl alcohol.

8. The substrate processing apparatus according to claim 1,
wherein the chamber includes a bottom portion defining a butt that is disposed in the internal space of the chamber and stores the removal liquid discharged from the exhaust cleaning device.

9. The substrate processing apparatus according to claim 1, further comprising:
a cleaning liquid nozzle that cleans an interior of the chamber by discharging cleaning liquid, which is the same type of liquid as the removal liquid discharged by the exhaust cleaning device, within the chamber,
wherein the chamber includes a bottom portion defining a butt that is disposed in the internal space of the chamber and stores the cleaning liquid discharged from the cleaning liquid nozzle.

10. The substrate processing apparatus according to claim 1, comprising:
a plurality of the chambers;
a plurality of the exhaust cleaning devices that correspond to the chambers, respectively;
a plurality of the individual exhaust flow paths that are connected to the chambers, respectively; and
a collection exhaust flow path that is connected to the individual exhaust flow paths.

11. The substrate processing apparatus according to claim 10,
wherein the individual exhaust flow paths include respective exhaust outlets that discharge atmospheres, exhausted from the chambers, into the collection exhaust flow path,
the exhaust outlets are open at an inner surface of the collection exhaust flow path and are spaced in the vertical direction when seen horizontally and
a canopy portion that is protruded from an upper edge of the exhaust outlet into the collection exhaust flow path is provided in at least one of the exhaust outlets.

12. The substrate processing apparatus according to claim 11,
wherein two of the canopy portions are respectively provided in the exhaust outlets adjacent to each other in the exhaust direction, and
when the two canopy portions are seen vertically from above, at least a portion of the canopy portion on a downstream side in the exhaust direction is hidden by the canopy portion on an upstream side in the exhaust direction.

13. The substrate processing apparatus according to claim 1, further comprising;
a valve member that is arranged within the individual exhaust flow path and that changes a flow rate of an atmosphere exhausted from the chamber to the individual exhaust flow path by changing a flow passage area of the individual exhaust flow path,
wherein the exhaust cleaning device forms the dispersion region at a position within the individual exhaust flow path by discharging the removal liquid toward the valve member.
